(19) United States
(12) Patent Application Publication
(10) Pub. No.: US 2017/0168311 A1
(43) Pub. Date: Jun. 15, 2017

(54) LAMPSHADE FOR STEREO 360 CAPTURE

(71) Applicant: GOOGLE INC., Mountain View, CA (US)

(72) Inventor: Andrew Ian Russell, San Jose, CA (US)

(21) Appl. No.: 15/375,990

(22) Filed: Dec. 12, 2016

Related U.S. Application Data
(60) Provisional application No. 62/266,302, filed on Dec. 11, 2015.

(51) Int. Cl. G02B 27/26; H04N 13/02

(52) U.S. Cl. CPC G02B 27/26; H04N 13/0242; H04N 13/0282

(57) ABSTRACT

An apparatus includes at least one camera and a refractor configured to change a direction of a light toward a lens of the camera. The refractor has a shape configured to redirect light representing an image at two focal points, the two focal points are on a same plane and at a same distance from the at least one camera, and the refractor is positioned between the two focal points and the at least one camera.

### CROSS-REFERENCE TO RELATED APPLICATION

This application claims priority to, and is a continuation of, U.S. Provisional Patent Application No. 62/266,302, filed on Dec. 11, 2015, entitled “LAMPSHADE FOR STEREO 360 CAPTURE”, the disclosure of which is incorporated by reference herein in its entirety.

### FIELD

Embodiments relate to three dimensional (3D) 360 degree and/or spherical image and/or video capture.

### BACKGROUND

360 degree and/or spherical image capture can be accomplished by capturing a plurality of images (substantially at the same time) and then stitching the plurality of images together to form a 360 degree and/or spherical image. Three dimensional (3D) images can be captured at two focal points (e.g., representing focal points of human eyes). 3D 360 degree video replay can involve repetitively stitching together the plurality of images for each eye. Therefore, 3D 360 degree video generation and encoding can be processor intensive.

### SUMMARY

In a general aspect, an apparatus includes at least one camera and a refractor configured to change a direction of a light toward a lens of the camera. The refractor has a shape configured to redirect light representing an image at two focal points, the two focal points are on a same plane and at a same distance from the at least one camera, and the refractor is positioned between the two focal points and the at least one camera.

In another general aspect, an apparatus comprising at least one camera and a reflector configured to change a direction of a light toward a lens of the camera. The reflector has a shape configured to redirect light representing an image at two focal points, the two focal points are on a same plane and at a same distance from the at least one camera, and the reflector is positioned at the center of the apparatus.

In yet another general aspect, an apparatus comprising at least one camera and a refractor configured to change a direction of a light toward a lens of the camera. The refractor has a shape configured to redirect light representing an image at a first focal point, and redirect light representing the image at a second focal point, and the two focal points are on a same plane and at a same distance from the at least one camera. The refractor includes at least one first polarizer configured to pass the light representing the image from first focal point and block the light representing the image from second focal point, and the refractor includes at least one second polarizer configured to pass the light representing the image from second focal point and block the light representing the image from first focal point.

Implementations can include one or more of the following features. For example, the two focal points represent a perspective with respect to a position of the at least one camera. The light representing the image includes a plurality of first rays and a plurality of second rays, the plurality of first rays has a corresponding first direction of approach, the plurality of second rays has a corresponding second direction of approach, a first of the two focal points is associated with the first direction of approach, and a second of the two focal points is associated with the second direction of approach. For example, the refractor is constructed of a material having a coefficient of refraction different than the surrounding atmosphere. The refractor includes a surface having a plurality of peaks and a plurality of valleys each connected by a facet. The refractor is formed to have at least one side with a zigzag or saw-tooth shape. A first surface of the facet is configured to change the direction of the light toward the lens of the camera by reflecting the light when the light contacts the surface, and a second surface of the facet is configured to allow the light to pass through when the light contacts the second surface.

For example, each facet includes an inner facet centered on an associated peak, each inner facet transitions at an associated valley, and each inner facet is curved. For example, the refractor includes a polarizer layer, the polarizer layer includes a plurality of clockwise polarizers, a plurality of counterclockwise polarizers, and a plurality of facet boundary blocks, each of the plurality of clockwise polarizers is configured to pass light rays having a clockwise polarization and block light rays having a counterclockwise polarization, each of the plurality of counterclockwise polarizers can be configured to pass light rays having a counterclockwise polarization and block light rays having a clockwise polarization, and each of the plurality of facet boundary blocks is configured to block light rays contacting the refractor at a plurality of peaks of the refractor and at a plurality of valleys of the refractor. An inner wall of the refractor is curved to focus at least one light ray of the light toward the lens.

For example, the first focal point and the second focal point each represent a perspective with respect to a position of the at least one camera. The refractor is constructed of a material having a coefficient of refraction different than the surrounding atmosphere. The refractor includes a plurality of peaks and a plurality of valleys each connected by a facet, a first surface of the facet is configured to change the direction of the light toward the lens of the camera by reflecting the light when the light contacts the surface, and a second surface of the facet is configured to allow the light to pass through when the light contacts the second surface. The refractor includes a plurality of peaks and a plurality of valleys each connected by a facet, each facet includes an inner facet centered on an associated peak, each inner facet transitions at an associated valley, and each inner facet is curved. An inner wall of the refractor is curved to focus at least one light ray of the light toward the lens.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1A illustrates a block diagram of an apparatus configured to capture a 3D 360 degree image and/or video frame according to at least one example embodiment.

FIG. 1B illustrates a block diagram of an apparatus configured to capture a 3D 360 degree image and/or video frame according to at least one example embodiment.

FIG. 2 illustrates 360 degrees of light rays to be captured by a camera.

FIG. 3 illustrates a camera rig including a plurality of cameras fixed on a structure.

FIG. 4 illustrates a left eye panorama.

FIG. 5 illustrates a right eye panorama.

FIG. 6 illustrates a top view of a refractor according to at least one example embodiment.

FIG. 7 illustrates a side view of the refractor according to at least one example embodiment.

FIG. 8 illustrates a camera system according to at least one example embodiment.

FIG. 9 illustrates an example implementation of the refractor according to at least one example embodiment.

FIG. 10 illustrates an example implementation of the refractor according to at least one example embodiment.

FIG. 11 illustrates an example implementation of the refractor according to at least one example embodiment.

FIG. 12 illustrates an example implementation of the refractor according to at least one example embodiment.

FIG. 13 illustrates an example implementation of the refractor according to at least one example embodiment.

FIG. 14 illustrates an example implementation of the refractor according to at least one example embodiment.

FIG. 15 illustrates an example implementation of a portion of a refractor according to at least one example embodiment.

FIG. 16 illustrates a side view of a refractor according to at least one example embodiment.

FIG. 17 illustrates a side view of a camera system according to at least one example embodiment.

FIG. 18 illustrates a top view of the camera system according to at least one example embodiment.

FIG. 19 illustrates a portion of a top view of a camera system according to at least one example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

There is provided an apparatus for capturing a 360 degree image or video frame. The image or images may be a stereoscopic or 3D, or capable or being reproduced as stereoscopic or 3D image. The apparatus can include at least one camera and a refractor. The refractor can be configured to change a direction of a light toward a lens of the camera. The refractor can have a shape configured to redirect light representing an image at two focal points. The two focal points can be on a same plane and at a same distance from the at least one camera. The refractor can be positioned between the two focal points and the at least one camera. The camera may be configured to capture images or video representing the images at the two focal points. The two focal points may be spaced in the plane by a nominal distance between pupils, namely a nominal pupillary distance. The refractor may include at least one first polarizer configured to pass light representing the image from first focal point and block the light representing the image from second focal point, and, the refractor may include at least one second polarizer configured to pass the light representing the image from second focal point and block the light representing the image from first focal point.

Another apparatus is provided. The apparatus may be for capturing a 360 degree image or video frame. The image or images may be a stereoscopic or 3D, or capable or being reproduced as stereoscopic or 3D image. The apparatus can include at least one camera and a reflector. The reflector can be configured to change a direction of a light toward a lens of the camera. The reflector can have a shape configured to redirect light representing an image at two focal points. The two focal points can be on a same plane and at a same distance from the at least one camera. The reflector can be positioned at the center of the apparatus. The camera may be configured to capture images or video representing the images at the two focal points. The two focal points may be spaced in the plane by a nominal distance between pupils, namely a nominal pupillary distance.

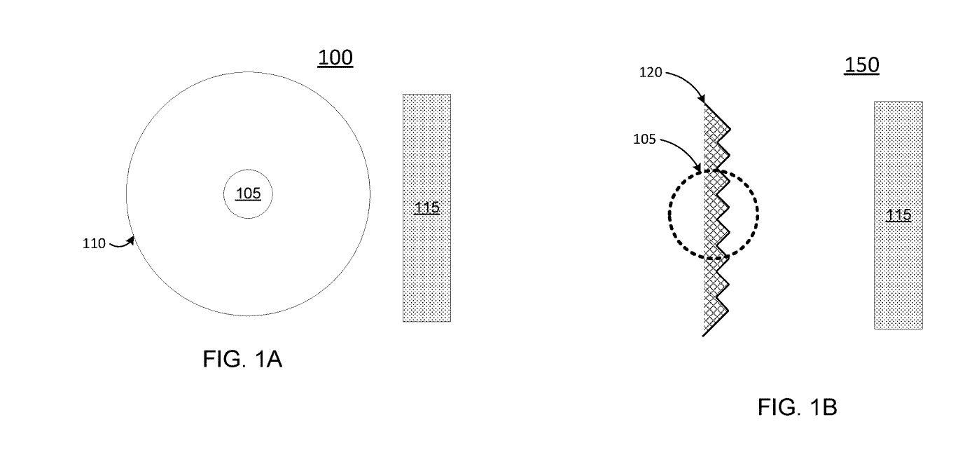

FIG. 1A illustrates a block diagram of an apparatus 100 configured to capture a 3D 360 degree image and/or video frame according to at least one example embodiment. As shown in FIG. 1A, the apparatus 100 includes a camera rig 105 and a refractor 110. The camera rig 100 can include at least one camera configured to capture an image associated with a surrounding scene 115. The refractor 110 can be configured to redirect light representing the image associated with the surrounding scene 115 at two focal points. The two focal points can be on a same plane and at a same distance from the camera rig 105. As shown in FIG. 1, the refractor 110 can be positioned between the surrounding scene 115 and the camera rig 105.

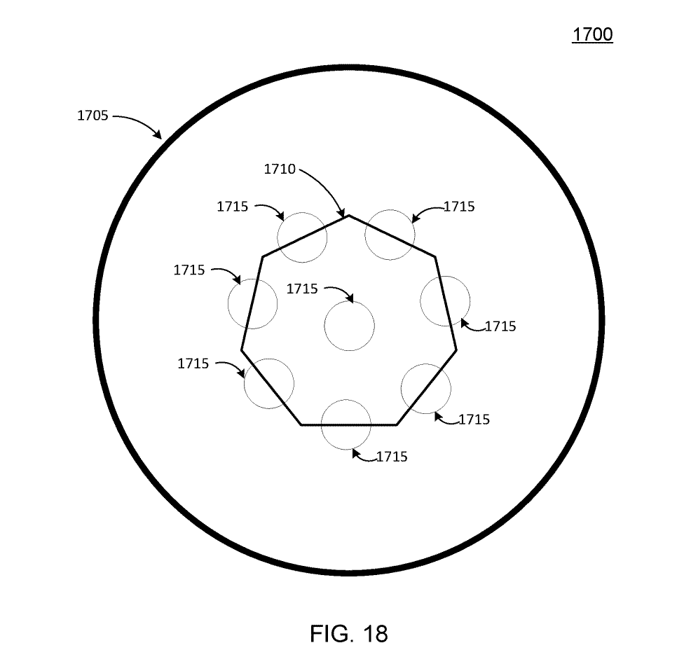

FIG. 1B illustrates a block diagram of an apparatus 150 configured to capture a portion of a 3D 360 degree image and/or video frame according to at least one example embodiment. As shown in FIG. 1B, the apparatus 150 includes a camera 105 and a reflector 120. The camera 105 can include at least one camera configured to capture an image associated with a surrounding scene 115. The reflector 120 can be configured to redirect light representing the image associated with the surrounding scene 115 at two focal points. The two focal points can be on a same plane and at a same distance from the at least one camera. The reflector 120 can be positioned at the center of the apparatus such that the camera 105 is between the reflector 120 and the surrounding scene 115. The camera 105 can also be positioned such that the light representing the image associated with the surrounding scene 115 is not blocked (e.g., in the way of) by the camera 105. The reflector 120 can be one of a plurality of reflectors. For example, the reflector 120 can be one facet of a plurality of facets positioned so that a 3D 360 degree image and/or video frame can be captured (see, for example, FIG. 18 below).

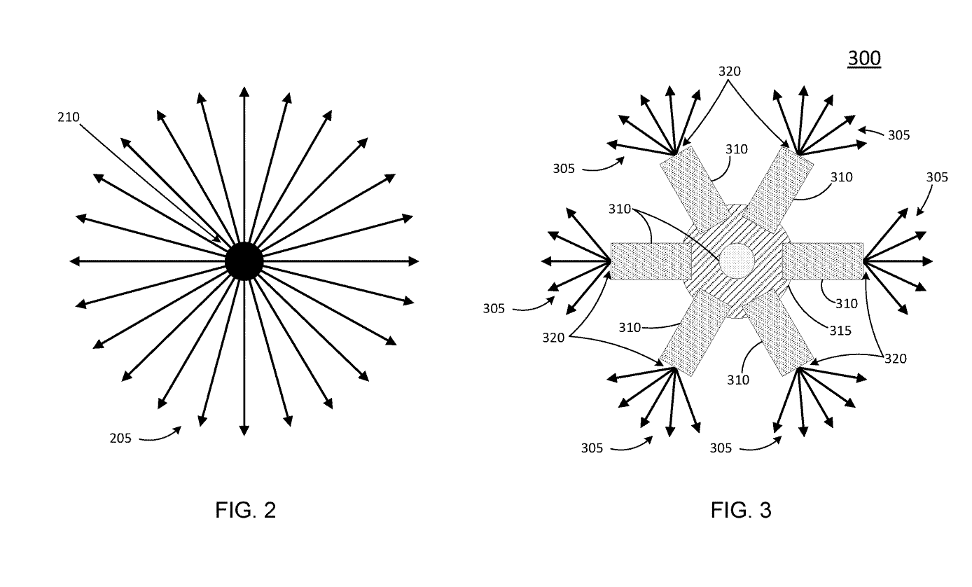

FIG. 2 illustrates 360 degrees of light rays 205 (e.g., representing an image) that should be captured by a camera (e.g., positioned at the center 210). In the example shown in FIG. 2, if all of the light rays 205 were to be captured as an image, the image would represent a full 360 degree scene. However, cameras alone are not capable of capturing such an image. For example, a single camera would be positioned and re-positioned (e.g., rotated) to capture a plurality of images which are then stitched together. Alternatively, a camera rig can include a plurality of cameras each capturing an image which is then stitched together with other images captured at substantially the same moment in time.

FIG. 3 illustrates a camera rig 300 including a plurality of cameras 310 fixed on a structure 315. The plurality of cameras 310 are configured to capture light rays 305 representing a plurality of images of a scene surrounding the camera rig. Unlike the light rays 205 illustrated in FIG. 2 (which are focused at the center 210), the light rays 305 are focused at a point 320 associated with, for example, a lens of each of the plurality of cameras 310. Accordingly, none of the plurality of cameras 310 alone captures a 360 degree image associated with the light rays 305. Instead, the plurality of cameras 310 can be oriented to capture individual images associated with the light rays 305 such that each of the individual images overlaps. Then the images can be stitched together forming a 360 degree image.

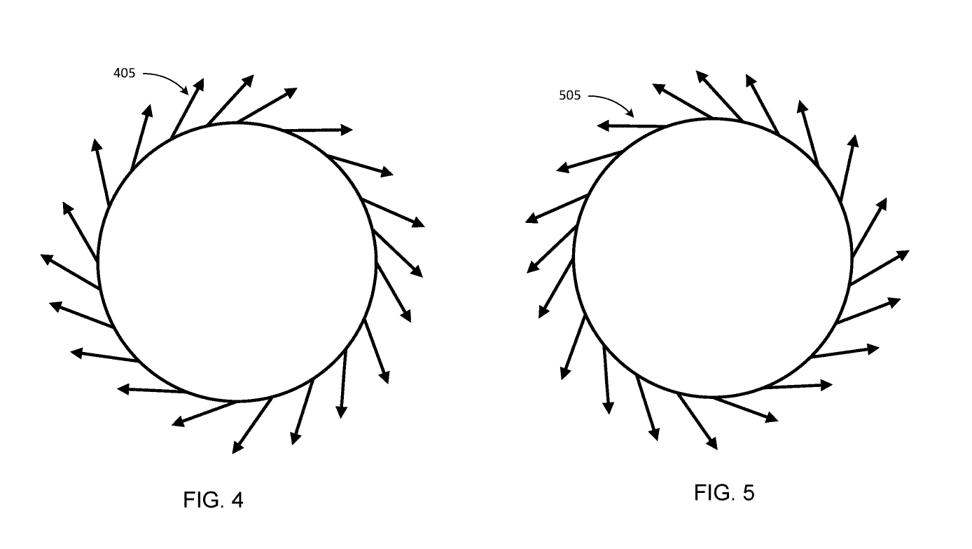

FIG. 4 illustrates a left eye panorama and FIG. 5 illustrates a right eye panorama. In each panorama light rays 405 and 505 are shown as having opposite point of view (appears as a rotation, but is a direction of approach) with respect to an eye (not shown) at a center of the panorama. An image combining each panorama can be a 3D image (or video frame) when viewed by a user (e.g., of a head mount display). As shown in FIG. 4, light rays 405 have a clockwise orientation or perspective. As shown in FIG. 5, light rays 505 have a counterclockwise orientation or perspective.

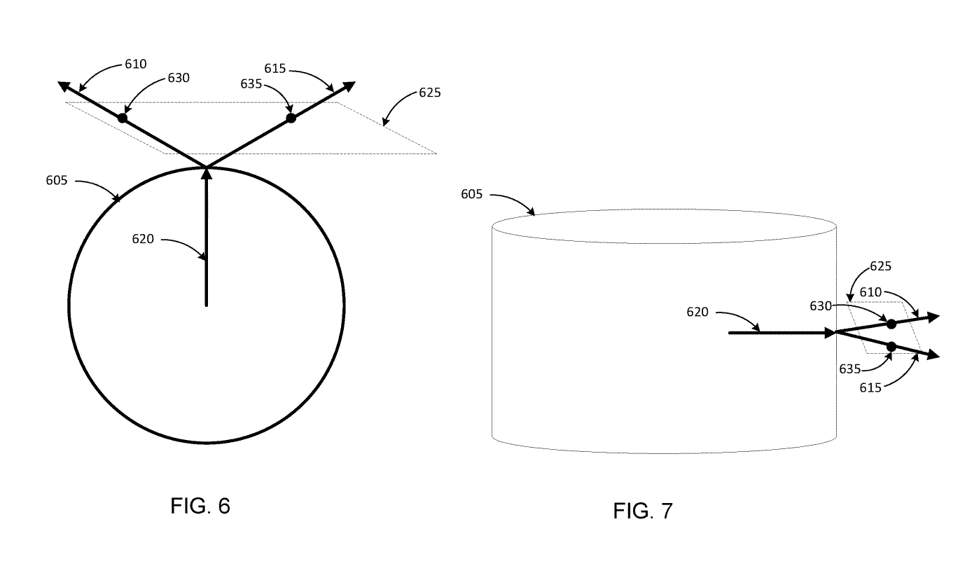

FIG. 6 illustrates a top view of a refractor 605 according to at least one example embodiment. FIG. 7 illustrates a side view of the refractor 605 according to at least one example embodiment. As shown in FIGS. 6 and 7, a first light ray 610 and second light ray 615 combine into (or emit from) a single light ray 620. Although the light rays 610, 615 and 620 are shown as emitting from the center of and away from the refractor 605, the light rays 610, 615 and 620 can travel in the opposite direction. Light rays 610 and 615 are shown as being on (or contained in) a plane 625. Points 630 and 635 are on the line representing the light rays 610 and 615, respectively. Point 630 can represent a focal point of a left eye (not shown) and point 635 can represent a focal point of a right eye (not shown).

Accordingly, an image associated with light ray 620 includes a portion representing both point 630 and 635. As such, the image includes both a left eye point of view and a right eye point of view when played back on a 3D viewer (e.g., head mount display). The refractor 605 can have a shape and be formed of a material configured to redirect light rays 610 and 615 representing an image at two focal points 630 and 635. The two focal points 630 and 635 can be on a same plane 625 and at a same distance from a camera (e.g., positioned on the line representing light ray 620). The refractor 605 can be positioned between the two focal points 630, 635 and the camera (not shown).

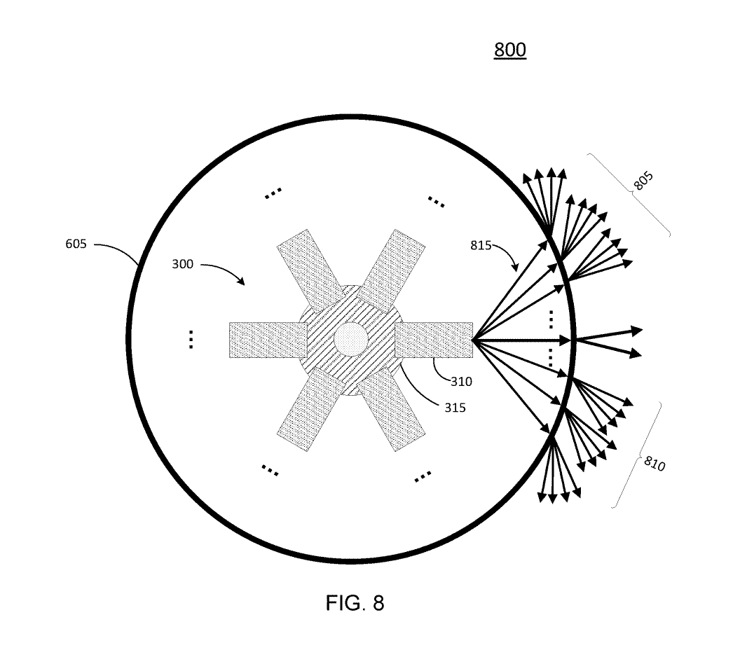

FIG. 8 illustrates a camera system 800 according to at least one example embodiment. As shown in FIG. 8, the camera system 800 includes the camera rig 300 and the refractor 605. FIG. 8 illustrates the refractor 605 as surrounding the camera rig 300. As such, FIG. 8 is similar to FIGS. 6 and 7 with the addition of the camera rig 300.

As shown in FIG. 8 light rays 805, 810 and 815 are shown as emitting from the camera 310 and away from the refractor 605. However, the light rays 805, 810 and 815 can travel in the opposite direction. Light rays 805, 810 are illustrated as having characteristics consistent with both the light rays 205 as illustrated in FIG. 2 and the light rays 405, 505 illustrated in FIGS. 4 and 5. Accordingly, refractor 605 can be configured to refract or shift light rays associated with two points on a plane (e.g., representing focal points of each eye) and refract or shift a plurality of light ray such that a camera 310 (or plurality of cameras in a camera rig 300) can capture (or substantially capture) a 360 degree image (or video frame). In other words refractor 605 can be configured to refract or shift light rays such that a 360 degree image for both eyes can be captured (e.g., for future display in a HMD) by camera 300.

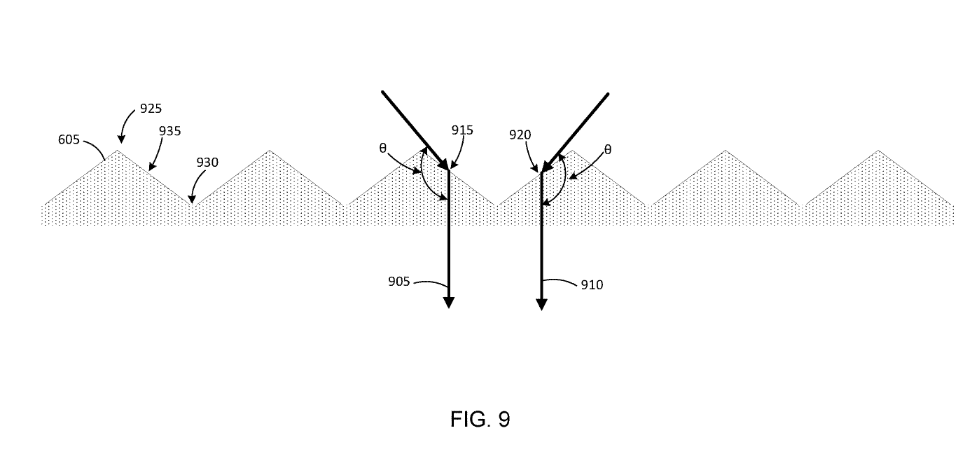

FIG. 9 illustrates an example implementation of the refractor 605 according to at least one example embodiment. As shown in FIG. 9, the refractor 605 can be formed having at least one side with a zigzag or sawtooth shape or pattern. For example, the refractor 605 illustrated in FIG. 9 has a plurality of peaks 925 and valleys 930 connected by a facet 935.

The refractor 605 can be constructed of a material having a coefficient of refraction (index of refraction or refractive index) different than the surrounding atmosphere (e.g., air). For example, the refractor 605 can be constructed of a material having a coefficient of refraction that causes the light ray 905, 910 to refract at an angle θ (e.g., the critical angle) at position 915, 920 along facet 935. Angle θ can be an angle that causes light ray 905, 910 to refract toward camera rig 300 (e.g., where light ray 905, 910 may not have otherwise been captured by camera rig 300 (or a particular one of the associated cameras) without repositioning camera 300). For example, the refractor 605 can be constructed of fused silica, polycarbonate, acrylic, acrylic glass and/or the like.

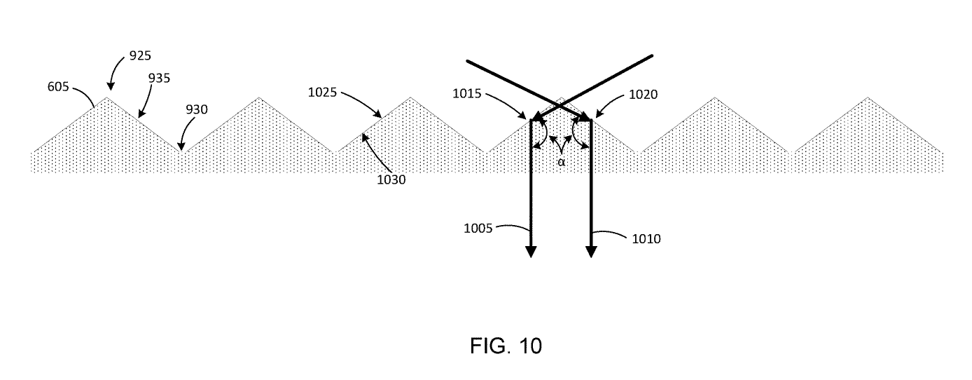

FIG. 10 illustrates an example implementation of the refractor 605 according to at least one example embodiment. As shown in FIG. 9, the refractor 605 can be formed having at least one side with a zigzag or sawtooth shape or pattern. For example, the refractor 605 illustrated in FIG. 10 has a plurality of peaks 925 and valleys 930 connected by a facet 935. A first surface 1030 of the facet 935 (e.g., the surface facing the camera rig 300) can be configured to reflect a light ray 1005, 1010 when the light ray 1005, 1010 contacts the first surface 1030. A second surface 1025 of the facet 935 (e.g., the surface opposite the camera rig 300) can be configured to allow a light ray 1005, 1010 to pass through when the light ray 1005, 1010 contacts the second surface 1025.

The first surface 1030 can be constructed of a material having a reflective property. For example, the first surface 1030 can be constructed of a material having a reflective property that causes the light ray 1005, 1010 to reflect at an angle a at position 1015, 1020 along facet 935. Angle a can be an angle that causes light ray 1005, 1010 to reflect toward camera rig 300 (e.g., where light ray 1005, 1010 may not have otherwise been captured by camera rig 300 (or a particular one of the associated cameras) without repositioning camera 300).

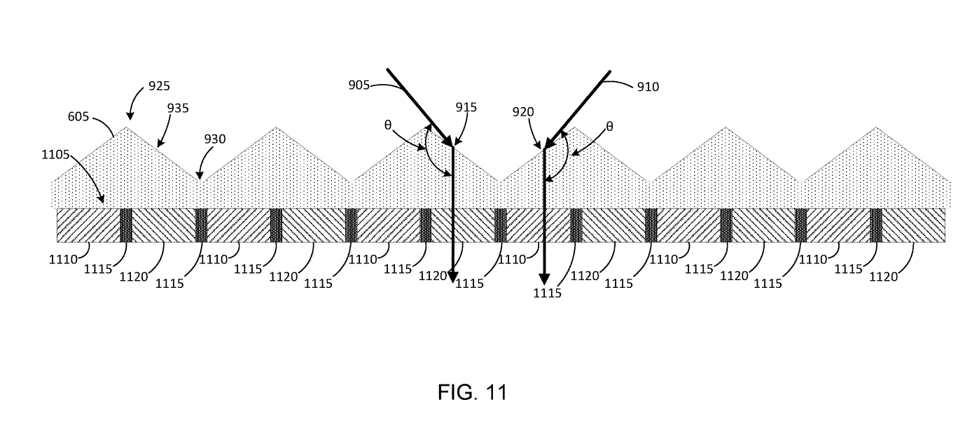

FIG. 11 illustrates an example implementation of the refractor 605 according to at least one example embodiment. As shown in FIG. 11, the refractor 605 can further include a polarizer layer 1105. The polarizer layer 1105 includes a plurality of clockwise polarizers 1110, a plurality of counterclockwise polarizers 1120 and a plurality of facet boundary blocks 1115. Each of the plurality of clockwise polarizers 1110 can be configured to pass light rays having a clockwise polarization and block (or absorb) light rays having a counterclockwise polarization. For example, each of the clockwise polarizers 1110 can be configured to scatter counterclockwise light rays. Each of the plurality of counterclockwise polarizers 1120 can be configured to pass light rays having a counterclockwise polarization and block (or absorb) light waves having a clockwise polarization. For example, each of the counterclockwise polarizers 1120 can be configured to scatter clockwise light rays.

Scattering a light ray can be caused by vibrating electrons of a medium when the electrons are struck by a light ray. The vibrating electrons can then generate an electromagnetic wave that is radiated outward in all directions. The generated electromagnetic wave strikes neighboring atoms, forcing their electrons into vibrations. These vibrating electrons produce another electromagnetic wave that is once more radiated outward in all directions. This absorption and reemission of light rays causes the light to be scattered about the medium.

Accordingly, each of the clockwise polarizers 1110 can be formed of a medium that absorbs counterclockwise light rays and each of the counter clockwise polarizers 1120 can be formed of a medium that absorbs clockwise light rays. Polarization by scattering can reduce glare associated with a captured image. Accordingly, including the polarizer layer 1105 with the refractor 605 can reduce glare associated with an image captured by the camera rig 300.

Each of the plurality of facet boundary blocks 1115 can be configured to block light rays contacting the refractor 605 at the plurality of peaks 925 and valleys 930. Light rays contacting the refractor 605 at the plurality of peaks 925 and valleys 930 can include a high concentration of both clockwise and counterclockwise light rays resulting in a significant amount of glare in a captured image. Accordingly, including the plurality of facet boundary blocks 1115 can reduce glare associated with an image captured by the camera rig 300.

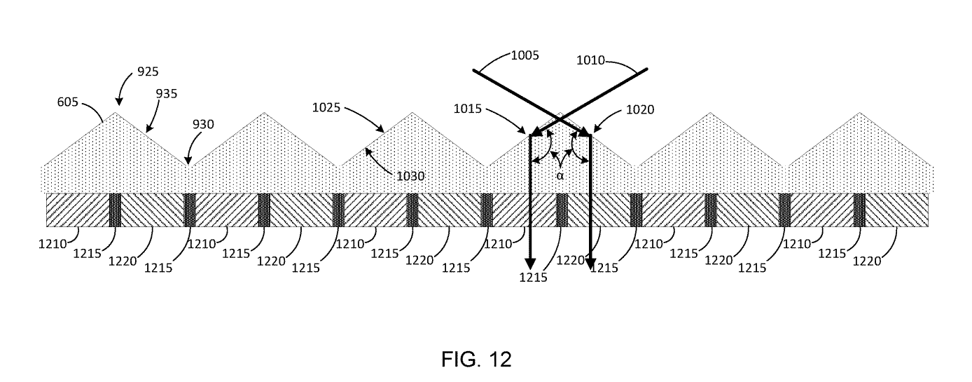

FIG. 12 illustrates an example implementation of the refractor 605 according to at least one example embodiment. As shown in FIG. 12, the refractor 605 can further include a polarizer layer 1205. The polarizer layer 1205 includes a plurality of counterclockwise polarizers 1210, a plurality of clockwise polarizers 1220 and a plurality of facet boundary blocks 1215. Each of the plurality of counterclockwise polarizers 1210 can be configured to pass light rays having a counterclockwise polarization and block (or absorb) light rays having a clockwise polarization. For example, each of the counterclockwise polarizers 1210 can be configured to scatter clockwise light rays. Each of the plurality of clockwise polarizers 1220 can be configured to pass light rays having a clockwise polarization and block (or absorb) light waves having a counterclockwise polarization. For example, each of the clockwise polarizers 1220 can be configured to scatter counterclockwise light rays.

As discussed above, each of the counterclockwise polarizers 1210 can be formed of a medium that absorbs clockwise light rays and each of the clockwise polarizers 1220 can be formed of a medium that absorbs counterclockwise light rays. Polarization by scattering can reduce glare associated with a captured image. Accordingly, including the polarizer layer 1205 with the refractor 605 can reduce glare associated with an image captured by the camera rig 300.

Each of the plurality of facet boundary blocks 1215 can be configured to block light rays contacting the refractor 605 at the plurality of peaks 925 and valleys 930. Light rays contacting the refractor 605 at the plurality of peaks 925 and valleys 930 can include a high concentration of both clockwise and counterclockwise light rays resulting in a significant amount of glare in a captured image. Accordingly, including the plurality of facet boundary blocks 1215 can reduce glare associated with an image captured by the camera rig 300.

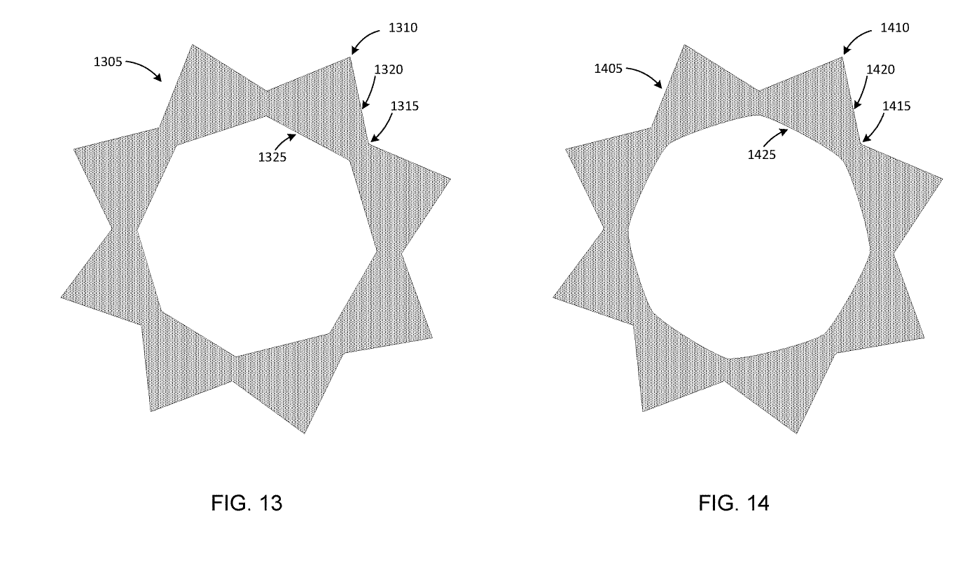

FIG. 13 illustrates an example implementation of the refractor 1305 according to at least one example embodiment. As shown in FIG. 13, the refractor 1305 can be formed having at least one side with a zigzag or sawtooth shape or pattern. For example, the refractor 1305 illustrated in FIG. 13 has a plurality of peaks 1310 and valleys 1315 each connected by a facet 1320. The refractor 1305 illustrated in FIG. 13 further includes a plurality of inner facets 1325. Each of the plurality of inner facets 1325 is illustrated as being centered on an associated peak 1310 and transitioning at an associated valley 1315. Each of the plurality of inner facets 1325 is further illustrated as being straight.

FIG. 14 illustrates an example implementation of the refractor 1405 according to at least one example embodiment. As shown in FIG. 14, the refractor 1405 can be formed having at least one side with a zigzag or sawtooth shape or pattern. For example, the refractor 1405 illustrated in FIG. 14 has a plurality of peaks 1410 and valleys 1415 each connected by a facet 1420. The refractor 1405 illustrated in FIG. 14 further includes a plurality of inner facets 1425. Each of the plurality of inner facets 1425 is illustrated as being centered on an associated peak 1410 and transitioning at an associated valley 1415. Each of the plurality of inner facets 1425 is further illustrated as being curved. Choosing between straight inner facets 1325 or curved inner facets 1425 can be based on focusing a light ray on a lens associated with a camera of a camera rig. For example straight inner facets 1325 may not refract a light ray, whereas curved inner facets 1425 may refract a light ray.

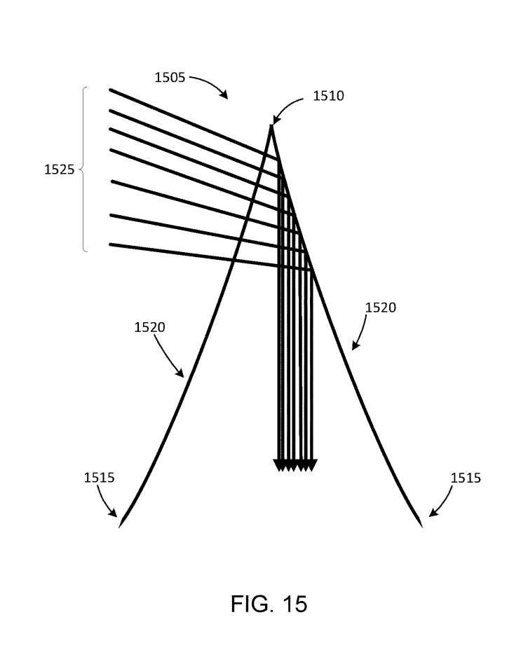

FIG. 15 illustrates an example implementation of a portion of a refractor 1505 according to at least one example embodiment. As shown in FIG. 15, the portion of the refractor 1505 can be one of the zigzag or sawtooth shape or pattern elements. For example, the portion of the refractor 1505 illustrated in FIG. 15 has a peak 1510 and two valleys 1515. The peak 1510 is connected to each of the valleys 1515 by facets 1520. Each facet 1520 is further illustrated as being curved. Accordingly, any of the previously illustrated refractors (e.g., refractor 605) can include curved facets 1520. Choosing between straight facets (e.g., facet 935) or curved facets 1520 can be based on a desired refraction (e.g., angle θ) of a light ray. For example, as shown in FIG. 15, the refractor 1505 can have curved facets 1520 configured to redirect light-rays 1525 that are fanning out. In other words, curved facets 1520 can be configured to introduce an optical power which causes light-rays 1525 to fan out providing an overlap (of captured light rays) between adjacent facets in the refractor 1505. In other words, the light rays 1525 before arriving at the facet 1520 may be converging but after reflection at the facet 1520 may be largely parallel, have a reduced degree of fan-out, or have increased focusing.

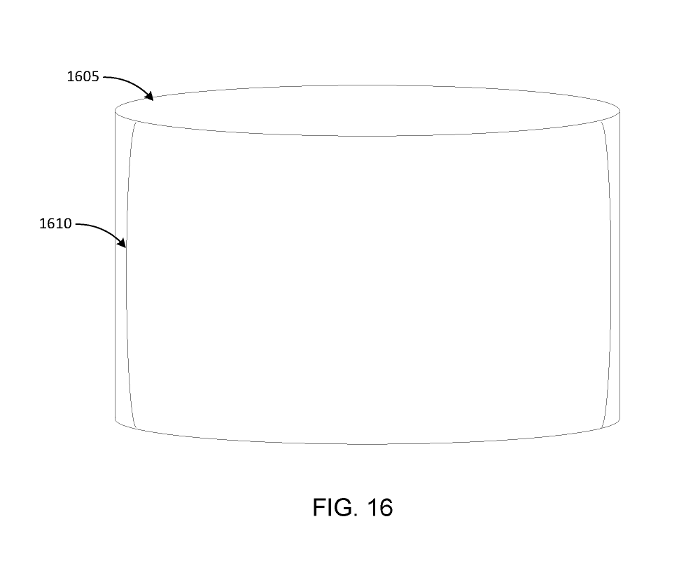

FIG. 16 illustrates a side view of a refractor 1605 according to at least one example embodiment. Refractor 1605 is similar to refractor 605 with the exception of a curved inner wall 1610. The curved inner wall 1610 may be configured to (or to help) focus (or direct) at least one light ray toward a lens associated with a camera of a camera rig. For example, the curved inner wall 1610 may further refract a light ray from top to bottom or bottom to top.

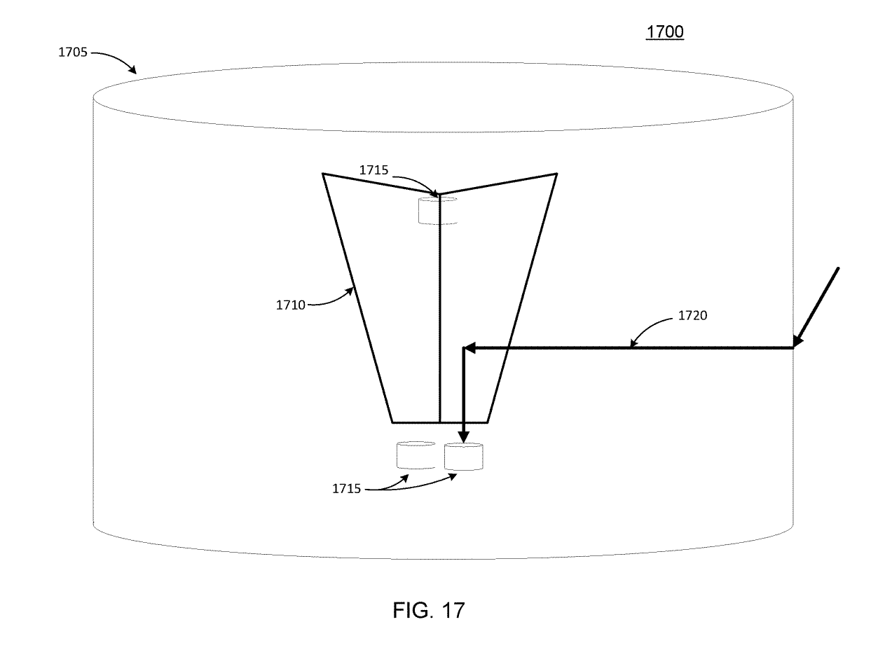

FIG. 17 illustrates a side view of a camera system 1700 according to at least one example embodiment. FIG. 18 illustrates a top view of the camera system 1700. As shown in FIGS. 17 and 18, the camera system 1700 includes a refractor 1705, a reflector 1710 and camera(s) 1715. The refractor 1705 can be configured to change a direction of a light ray. The refractor can have a shape configured to redirect light representing an image at two focal points. The two focal points can be on a same plane and at a same distance from the at least one camera. The refractor can be positioned between the two focal points and the at least one camera. The refractor 1705 can include any of the constructs described above.

The reflector 1710 can be configured to reflect a light ray toward a camera 1715. For example, a light ray 1720, initially external to the camera system 1700, can first be refracted toward the center of the camera system 1700 by the refractor 1705 (described in more detail above). The light ray 1720 can then be reflected toward the camera 1715 by the reflector 1710. The reflector 1710 can be formed of any reflective material. For example, the reflector 1710 can be a mirror. The camera(s) 1715 can be associated with a camera rig (e.g., camera rig 300).

Light ray 1720 can have characteristics consistent with both the light rays 205 as illustrated in FIG. 2 and the light rays 405, 505 illustrated in FIGS. 4 and 5. Accordingly, refractor 1705 can be configured to refract or shift light rays associated with two points on a plane (e.g., representing focal points of each eye) and refract or shift a plurality of light ray such that a camera 1715 (or plurality of cameras in a camera rig associated with cameras 1715) can capture (or substantially capture) a 360 degree image (or video frame). In other words refractor 1705 can be configured to refract or shift light rays such that a 360 degree image for both eyes can be captured (e.g., for future display in a HMD) by camera(s) 1715.

Another apparatus can include at least one camera and a reflector. The reflector can be configured to change a direction of a light toward a lens of the camera. The reflector can have a shape configured to redirect light representing an image at two focal points. The two focal points can be on a same plane and at a same distance from the at least one camera. The reflector can be positioned at the center of the apparatus.

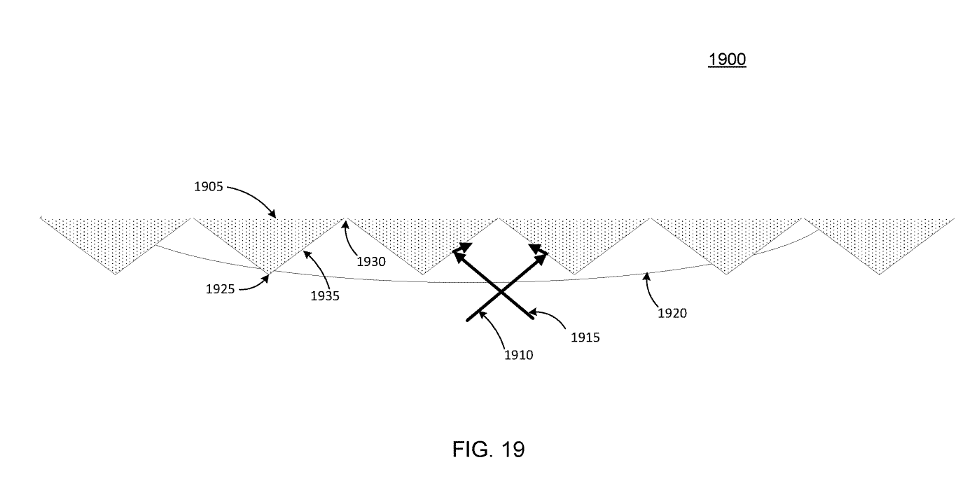

FIG. 19 illustrates a portion of a top view of a camera system 1900. As shown in FIG. 19, the camera system includes a reflector 1905 and a camera 1920. As shown in FIG. 19, the reflector 1905 can be formed having at least one side with a zigzag or sawtooth shape or pattern. For example, the reflector 1905 illustrated in FIG. 19 has a plurality of peaks 1925 and valleys 1930 connected by a facet 1935. The facet 1935 may be formed of a reflective material (e.g., a mirror) configured to reflect a light ray 1910, 1915 associated with a scene (external to the camera 1900) toward the camera 1920.

Light rays 1910 and 1915 can have characteristics consistent with both the light rays 205 as illustrated in FIG. 2 and the light rays 405, 505 illustrated in FIGS. 4 and 5. Accordingly, reflector 1905 can be configured to reflect or shift or change the direction of light rays associated with two points on a plane (e.g., representing focal points of each eye) and reflect or shift or change the direction a plurality of light rays such that a camera 1920 (or a plurality of cameras in a camera rig) can capture (or substantially capture) a 360 degree image (or video frame). In other words reflector 1905 can be configured to reflect or shift or change the direction light rays such that a 360 degree image for both eyes can be captured (e.g., for future display in a HMD) by camera 1920.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

What is claimed is:

1. An apparatus comprising:
at least one camera; and
a refractor configured to change a direction of a light toward a lens of the camera, wherein
the refractor has a shape configured to redirect light representing an image at two focal points,
the two focal points are on a same plane and at a same distance from the at least one camera, and
the refractor is positioned between the two focal points and the at least one camera.

2. The apparatus of claim 1, wherein the two focal points represent a perspective with respect to a position of the at least one camera.

3. The apparatus of claim 1, wherein
the light representing the image includes a plurality of first rays and a plurality of second rays,
the plurality of first rays has a corresponding first direction of approach,
the plurality of second rays has a corresponding second direction of approach,
a first of the two focal points is associated with the first direction of approach, and
a second of the two focal points is associated with the second direction of approach.

4. The apparatus of claim 1, wherein the refractor is constructed of a material having a coefficient of refraction different than the surrounding atmosphere.

5. The apparatus of claim 1, wherein the refractor is formed to have at least one side with a zigzag or saw-tooth shape.

6. The apparatus of claim 1, wherein
the refractor includes a surface having a plurality of peaks and a plurality of valleys each connected by a facet,
a first surface of the facet is configured to change the direction of the light toward the lens of the camera by reflecting the light when the light contacts the surface, and
a second surface of the facet is configured to allow the light to pass through when the light contacts the second surface.

7. The apparatus of any of claim 1, wherein
the refractor includes a surface having a plurality of peaks and a plurality of valleys each connected by a facet,
each facet includes an inner facet centered on an associated peak,
each inner facet transitions at an associated valley, and
each inner facet is curved.

8. The apparatus of claim 1, wherein
the refractor includes a polarizer layer,
the polarizer layer includes a plurality of clockwise polarizers, a plurality of counterclockwise polarizers, and a plurality of facet boundary blocks,
each of the plurality of clockwise polarizers is configured to pass light rays having a clockwise polarization and block light rays having a counterclockwise polarization,
each of the plurality of counterclockwise polarizers can be configured to pass light rays having a counterclockwise polarization and block light rays having a clockwise polarization, and
each of the plurality of facet boundary blocks is configured to block light rays contacting the refractor at a plurality of peaks of the refractor and at a plurality of valleys of the refractor.

9. The apparatus of claim 1, wherein an inner wall of the refractor is curved to focus at least one light ray of the light toward the lens.

10. An apparatus comprising:
at least one camera; and
a reflector configured to change a direction of a light toward a lens of the camera, wherein
the reflector has a shape configured to redirect light representing an image at two focal points,
the two focal points are on a same plane and at a same distance from the at least one camera, and
the reflector is positioned at the center of the apparatus.

11. The apparatus of claim 10, wherein the two focal points represent a perspective with respect to a position of the at least one camera.

12. The apparatus of claim 10, wherein
the light representing the image includes a plurality of first rays and a plurality of second rays,
the plurality of first rays has a corresponding first direction of approach,
the plurality of second rays has a corresponding second direction of approach,
a first of the two focal points is associated with the first direction of approach, and
a second of the two focal points is associated with the second direction of approach.

13. The apparatus of claim 10, wherein the reflector is formed having at least one side with a zigzag or saw-tooth shape.

14. The apparatus of claim 10, wherein
the reflector includes a plurality of peaks and a plurality of valleys each connected by a facet, and
a surface of the facet is configured to change the direction of the light toward the lens of the camera by reflecting the light when the light contacts the surface.

15. An apparatus comprising:
at least one camera; and
a refractor configured to change a direction of a light toward a lens of the camera, wherein
the refractor has a shape configured to:
redirect light representing an image at a first focal point, and
redirect light representing the image at a second focal point,
the first focal point and the second focal point are on a same plane and at a same distance from the at least one camera,
the refractor includes at least one first polarizer configured to pass the light representing the image from first focal point and block the light representing the image from second focal point, and
the refractor includes at least one second polarizer configured to pass the light representing the image from second focal point and block the light representing the image from first focal point.

16. The apparatus of claim 15, wherein the first focal point and the second focal point each represent a perspective with respect to a position of the at least one camera.

17. The apparatus of claim 15, wherein the refractor is constructed of a material having a coefficient of refraction different than the surrounding atmosphere.

18. The apparatus of claim 15, wherein
the refractor includes a plurality of peaks and a plurality of valleys each connected by a facet,
a first surface of the facet is configured to change the direction of the light toward the lens of the camera by reflecting the light when the light contacts the surface, and
a second surface of the facet is configured to allow the light to pass through when the light contacts the second surface.

19. The apparatus of claim 15, wherein
the refractor includes a plurality of peaks and a plurality of valleys each connected by a facet,
each facet includes an inner facet centered on an associated peak,
each inner facet transitions at an associated valley, and
each inner facet is curved.

20. The apparatus of claim 15, wherein an inner wall of the refractor is curved to focus at least one light ray of the light toward the lens.
